(19) United States
(12) Patent Application Publication
(10) Pub. No.: US 2006/0161536 A1
(43) Pub. Date: Jul. 20, 2006

(54) Directory with an associated query

(75) Inventors: Nathan Glenn Faiman, Rochester, MN (US); Bryan Mark Logan, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: International Business Machines Corporation, Armonk, NY (US)

(21) Appl. No.: 11/035,559

(22) Filed: Jan. 14, 2005

(51) Int. Cl. G06F 7/00; G06F 17/30

(52) U.S. Cl. 707/4

(57) ABSTRACT

A method, apparatus, system, and signal-bearing medium that, in an embodiment, in response to a read command directed to a first directory, a query associated with the first directory is performed against a second directory, and the results of the query are returned in response to the read command. In response to an open command directed to a file in the first directory, the associated query is performed against the second directory, and the file is found in the query results. A file handle associated with the file is then created. If the query has an associated API, an instance of the API is created and a pointer to the instance is stored in the file handle. In response to a file command directed to the file handle, if the file handle contains a pointer to the API instance, the file operation is passed to the API instance.

### FIELD

This invention generally relates to computer systems and more specifically relates to file system directories with associated queries of other directories.

### BACKGROUND

The development of the EDVAC computer system of 1948 is often cited as the beginning of the computer era. Since that time, computer systems have evolved into extremely sophisticated devices that may be found in many different settings. Computer systems typically include a combination of hardware (e.g., semiconductors, circuit boards, etc.) and software (e.g., computer programs). As advances in semiconductor processing and computer architecture push the performance of the computer hardware higher, more sophisticated computer software has evolved to take advantage of the higher performance of the hardware, resulting in computer systems today that are much more powerful than just a few years ago.

One of the primary purposes of computers is the storage, retrieval, and manipulation of data. Data in computers is often organized in a hierarchical structure analogous to a physical file cabinet. An office might have many file cabinets, with each different file cabinet reserved for a different type of data, and each file cabinet being further divided into folders, each of which contains paper or other information/data. Analogously, the storage of a computer is divided into directories (also known as folders), each of which may contain files and/or sub-directories (also known as sub-folders), each of which may be further divided, and so on as needed. Thus, a directory may contain a sub-directory and may also be a sub-directory. The files store the data and may be in any format, such as databases, tables, images, video files, audio files, word-processing documents, drawings, graphs, spreadsheets, programs, pages, or any other type of file. A user, system administrator, or application program may perform operations against the directories, such as creating, deleting, reading, renaming, reorganizing, and searching them.

Searching directories for files that match a certain criteria is an important function because of the large number of directories and files that may exist in a computer. The search operation may be implemented via a variety of techniques. For example, the application implementing the search may perform simple file I/O (Input/Output) to find all files on the computer system and determine which of them match the criteria. In a second example, the application may use file system-specific APIs (Application Program Interfaces) to access the list of files meeting the criteria. In a third example, the application may perform normal file I/O against a directory that is connected to a symbolic link directory via a query that specifies the search criteria.

For the simple I/O example, the application implements the query and reads files in the directory. Simple I/O has the disadvantage that the application is now more complex and may need to use more APIs to determine if a file matches the criteria, depending on the complexity of the criteria. Further, the criteria must also be input to the application, which adds an additional step with resulting complexity and performance degradation.

For the file system specific APIs example, the application sends the query to the file system, which has the advantage of being faster if the file system is backed by a database and can determine the results more quickly. Unfortunately, the file system specific APIs hurt the portability of the application, which may needed to be coded to support multiple API sets.

For the symbolic links example, the application accesses the files in the given directory using normal file I/O API's. Unfortunately, a separate process is needed to ensure that the symbolic links are always kept up to date. For example, the query may be stored in a background program, which constantly runs to maintain the relationship between the directory and the symbolic link directory. Also, if the criteria is based on user-specific properties (such as the access level), then a separate directory must be kept for every user.

Thus, without a better way to perform queries against directories, users will continue to suffer from lack of portability, degraded performance, and complexity.

### SUMMARY

A method, apparatus, system, and signal-bearing medium are provided that, in an embodiment, in response to a read command directed to a first directory, a query associated with the first directory is performed against a second directory, and the results of the query are returned in response to the read command. In response to an open command directed to a file in the first directory, the associated query is performed against the second directory, and the file is found in the query results. A file handle associated with the file is then created. If the query has an associated API, an instance of the API is created and a pointer to the instance is stored in the file handle. In response to a file command directed to the file handle, if the file handle contains a pointer to the API instance, the file command is passed to the API instance.

### BRIEF DESCRIPTION OF THE DRAWINGS

Various embodiments of the present invention are hereinafter described in conjunction with the appended drawings:

FIG. 1 depicts a high-level block diagram of an example system for implementing an embodiment of the invention.

FIG. 2 depicts a block diagram of an example directory, according to an embodiment of the invention.

FIG. 3A depicts a block diagram of an example create directory dialog with a query, according to an embodiment of the invention.

FIG. 3B depicts a block diagram of an example create directory dialog with a query having an API, according to an embodiment of the invention.

FIG. 4A depicts a block diagram of an example directory created in response to the create directory dialog with a query, according to an embodiment of the invention.

FIG. 4B depicts a block diagram of an example directory created in response to the create directory dialog with a query and an API, according to an embodiment of the invention.

FIG. 5A depicts a block diagram of an example query results, according to an embodiment of the invention.

FIG. 5B depicts a block diagram of an example query results after an API, according to an embodiment of the invention.

FIG. 6 depicts a flowchart of example processing for creating a directory, according to an embodiment of the invention.

FIG. 7 depicts a flowchart of example processing for reading a directory, according to an embodiment of the invention.

FIG. 8 depicts a flowchart of example processing for opening a file, according to an embodiment of the invention.

FIG. 9 depicts a flowchart of example processing for searching a directory for an i-node/vi-node, according to an embodiment of the invention.

FIG. 10 depicts a flowchart of example processing for finding a parent directory of an i-node, according to an embodiment of the invention.

FIG. 11 depicts a flowchart of example processing for performing a file operation, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

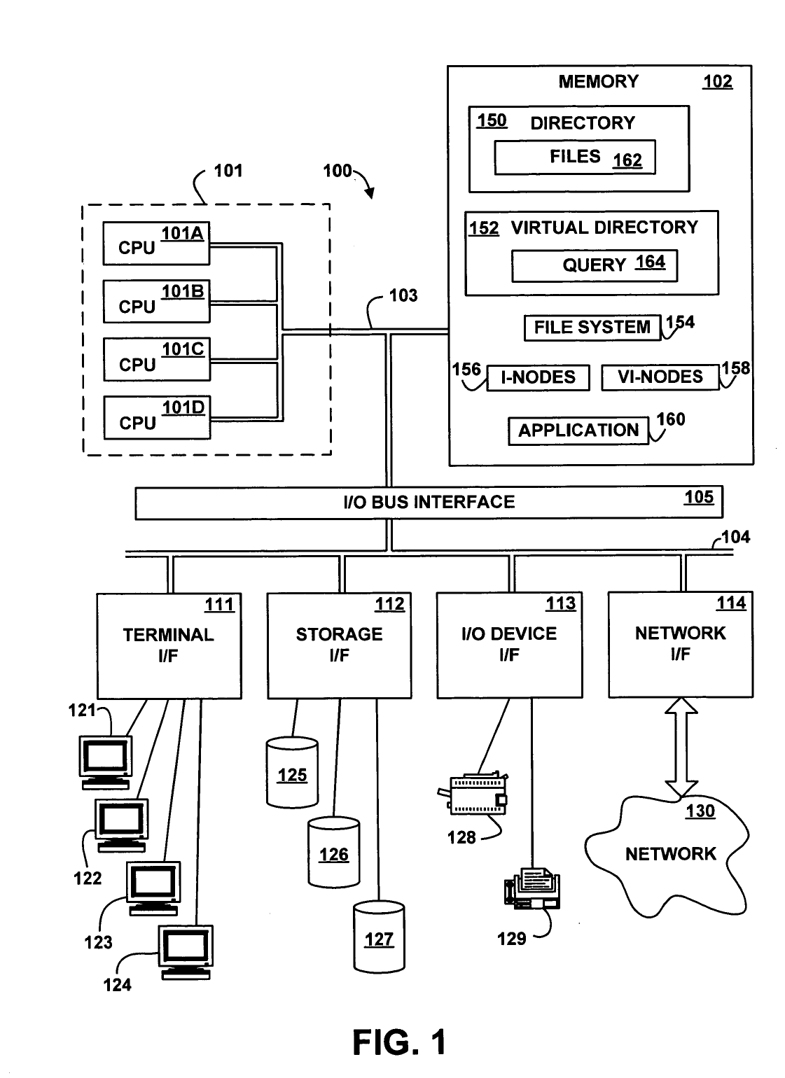

Referring to the Drawings, wherein like numbers denote like parts throughout the several views, FIG. 1 depicts a high-level block diagram representation of a computer system 100 connected to a network 130, according to an embodiment of the present invention. In an embodiment, the hardware components of the computer system 100 may be implemented by an IBM eServer iSeries computer system. However, those skilled in the art will appreciate that the mechanisms and apparatus of embodiments of the present invention apply equally to any appropriate computing system.

The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing data and programs. In another embodiment, the main memory 102 represents the entire virtual memory of the computer system 100, and may also include the virtual memory of other computer systems coupled to the computer system 100 or connected via the network 130. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The memory 102 includes a directory 150, a virtual directory 152, a file system 154, i-nodes 156, vi-nodes 158, and an application 160. Although the directory 150, the virtual directory 152, the file system 154, the i-nodes 156, the vi-nodes 158, and the application 160 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, the directory 150, the virtual directory 152, the file system 154, the i-nodes 156, the vi-nodes 158, and the application 160 are not necessarily all completely contained in the same storage device at the same time.

The directory 150 includes files 162 and may also include one or more unillustrated sub-directories in a hierarchical structure. The directory 150 may itself be a sub-directory contained within another directory. In an embodiment, the directory 150 and the files 162 may be organized and stored as UNIX directories and files, but in another embodiment any appropriate type of directories and files may be used. UNIX directories and files are hierarchical in that they resemble a tree structure. The tree is anchored at a place called the root, designated by a slash “/”. Every item in the UNIX file system tree is either a file, or a directory that can contain files and other directories. A directory contained within another is called the child of the other. A directory in the file system tree may have many children, but it can only have one parent. UNIX files can have attributes such as size, permissions, create time, among others, associated with it. For example, every file and directory may have associated ownership and access permissions for which one is able to specify those to whom the permissions apply.

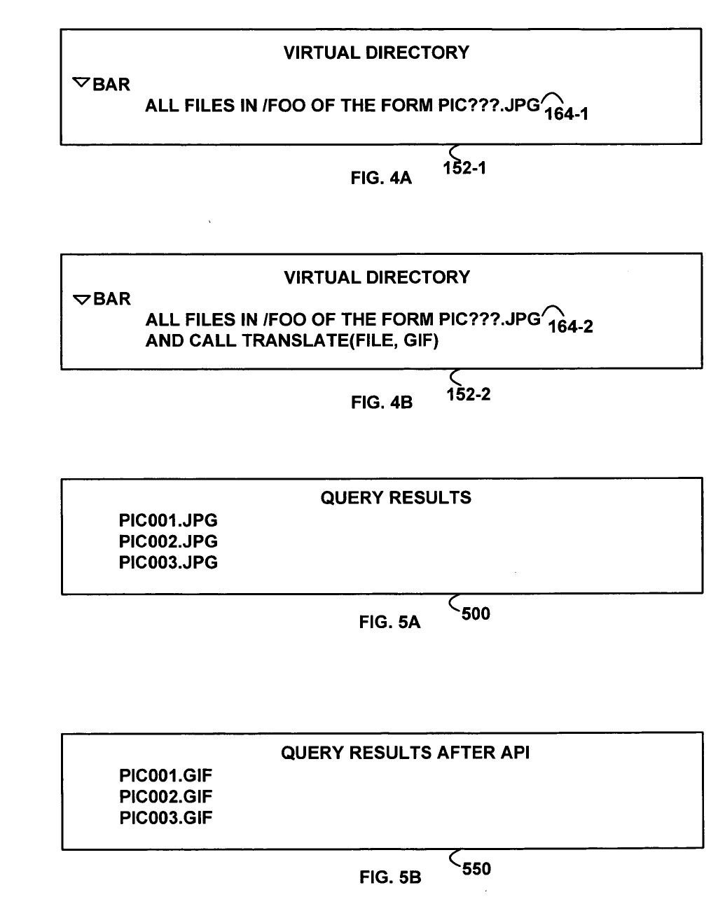

The virtual directory 152 includes a query 146. The virtual directory 152 is said to be virtual because it does not contain files, but instead contains the query 146, which may be used to find a file or files in the files 162, as further described below with reference to FIGS. 4A, 4B, 5A, 5B, 8, 9, and 10.

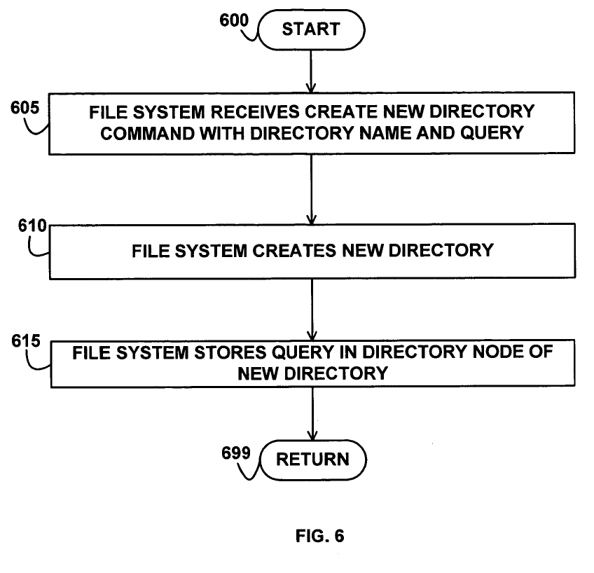

The file system 154 manages the directories 150, the files 162, the virtual directories 152, the queries 164, the i-nodes 156, and the vi-nodes 158, and performs such operations as creating directories, reading directories, performing queries, and performing file operations. In an embodiment, the file system 154 includes instructions capable of executing on the processor 101 or statements capable of being interpreted by instructions executing on the processor 101 to perform the functions as further described below with reference to FIGS. 6, 7, 8, 9, 10, and 11. In another embodiment, the file system 154 may be implemented in microcode. In another embodiment, the file system 154 may be implemented in hardware via logic gates and/or other appropriate hardware techniques. The application 160 sends commands or requests for file and directory operations to the file system 154.

The i-nodes 156 are data structures or information blocks that contain information about the files 162. Each file 162 has an i-node in the i-nodes 156 and is identified by an i-node number (i-number). The i-nodes 156 include information about the files 162, such as file ownership information (user and group ownership); time stamps for last modification, last access and last mode modification; link count; file size; and addresses of physical blocks.

The vi-nodes 158 are data structures or information blocks that contain information about the virtual directories 152, such as directory ownership information, time stamps for last modification, a query, and an action. The query in the vi-node 158 is a copy of the query 164, and the action is derived from the query.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI bus, or any other appropriate bus technology.

The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127.

The I/O and other device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol).

In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number (including zero) of networks (of the same or different types) may be present.

It should be understood that FIG. 1 is intended to depict the representative major components of the computer system 100 and the network 130 at a high level, that individual components may have greater complexity that represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements comprising the various aspects of an embodiment of the invention.

Moreover, while embodiments of the invention have and hereinafter will be described in the context of fully-functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of signal-bearing media, which include, but are not limited to:

(1) information permanently stored on a non-rewriteable storage medium, e.g., a read-only memory device attached to or within a computer system, such as a CD-ROM, DVD-R, or DVD+R;

(2) alterable information stored on a rewriteable storage medium, e.g., a hard disk drive (e.g., the DASD 125, 126, or 127), CD-RW, DVD-RW, DVD+RW, DVD-RAM, or diskette; or

(3) information conveyed by a communications medium, such as through a computer or a telephone network, e.g., the network 130, including wireless communications.

Such signal-bearing media, when carrying machine-readable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

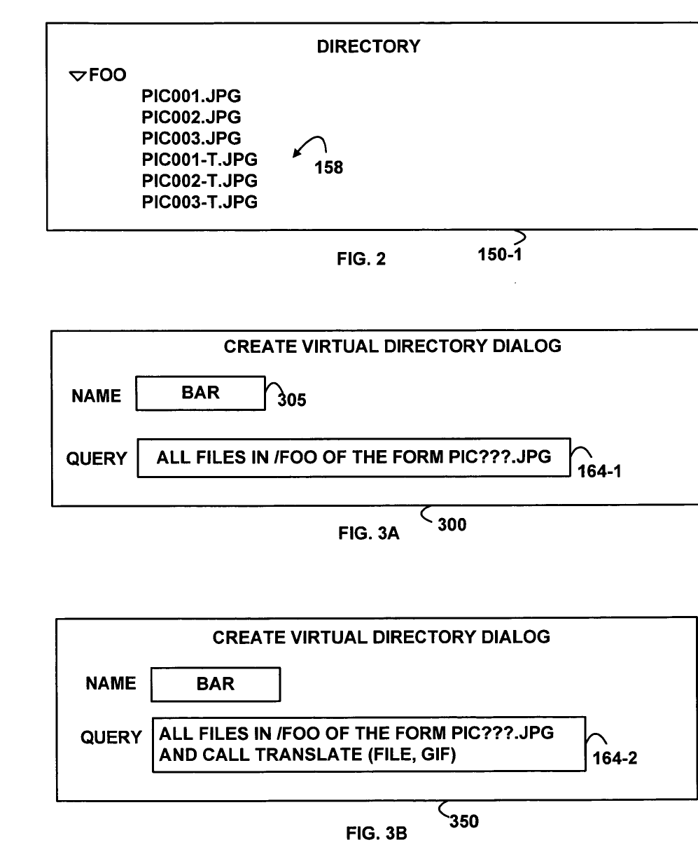

FIG. 2 depicts a block diagram of an example file listing 158 for the directory 150-1, according to an embodiment of the invention. The directory 150-1 is an example of the directory 150, as previously described above with reference to FIG. 1. The file listing 158 includes names of the files 162 that are in the directory 150-1. The file listing 158 is exemplary only, and in other embodiments nay appropriate file names or other information may be present.

FIG. 3A depicts a block diagram of an example create virtual directory dialog 300 with an example query 164-1, which is an example of the query 164 (FIG. 1), according to an embodiment of the invention. The query 164-1 identifies that the query is directed to the “/foo” directory, which in this example is the name of the directory 150-1, as previously described above with reference to FIG. 2. The file system 154 responds to the dialog 300 by creating a new virtual directory 152 containing the query 164-1, as further described below with reference to FIG. 6. The dialog 300 also includes a name 305 of the virtual directory to be created.

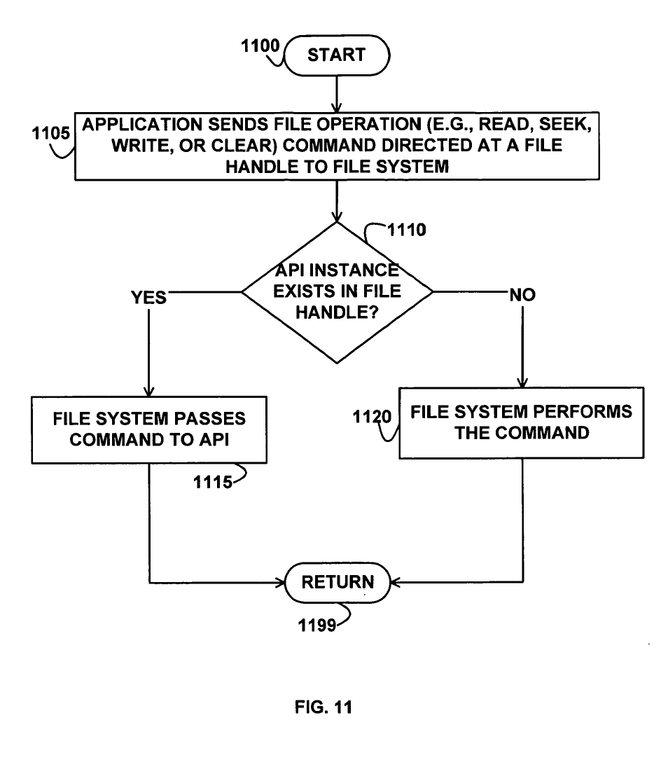

FIG. 3B depicts a block diagram of an example create virtual directory dialog 350 with an example query 164-2, which is an example of the query 164 (FIG. 1), according to an embodiment of the invention. The query 164-2 identifies that the query is directed to the “/foo” directory, which in this example is the name of the directory 150-1, as previously described above with reference to FIG. 2. The query 164-2 further includes an API (Application Program Interface), which in this example is a call to “Translate(file,gif).” The file system 154 responds to the dialog 350 by creating a new virtual directory 152 containing the query 164-2, as further described below with reference to FIG. 6. The API in the query 164-2 is processed as further described below with reference to FIG. 11.

FIG. 4A depicts a block diagram of an example listing for an example virtual directory 152-1 created by the file system 154 (see FIG. 6) in response to the create directory dialog 300 (FIG. 3A), according to an embodiment of the invention. The listing of the properties of the virtual directory 152-1 includes the query 164-1 from FIG. 3A.

FIG. 4B depicts a block diagram of an example listing for an example virtual directory 152-2 created by the file system 154 (see FIG. 6) in response to the create directory dialog 350 (FIG. 3B), according to an embodiment. The listing of the properties of the virtual directory 152-2 includes the query 164-2 with an API from FIG. 3B.

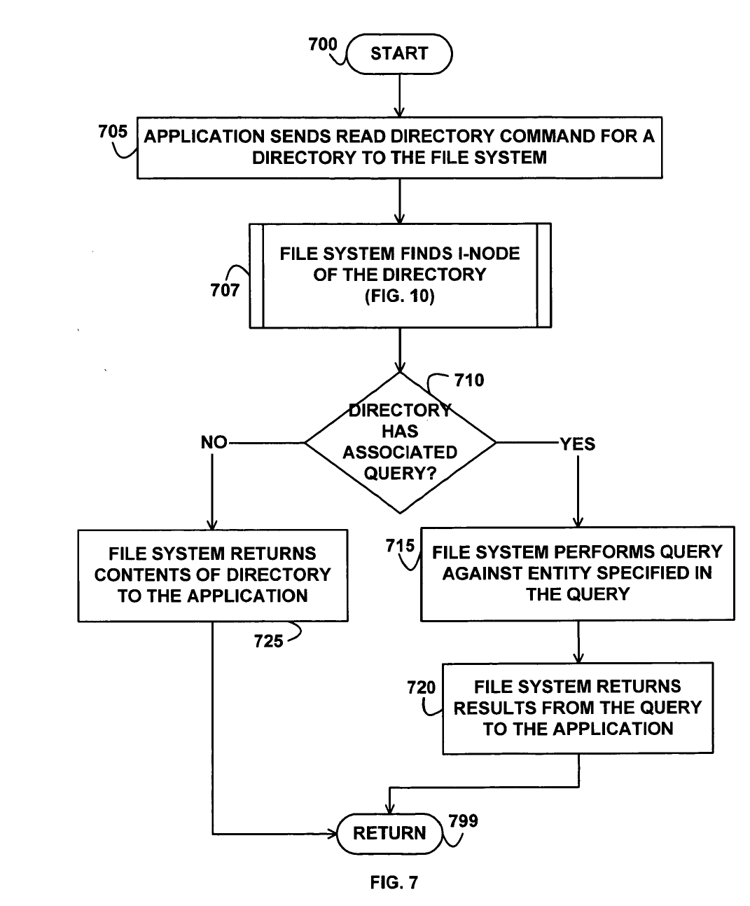

FIG. 5A depicts a block diagram of an example query results 500 produced by the file system 154 (as further described below with reference to FIG. 7) in response to a read directory command directed to the virtual directory 152-1 (FIG. 4A), which results in the query 164-1 being performed by the file system 154 against the directory 150 (FIG. 2), according to an embodiment of the invention.

FIG. 5B depicts a block diagram of an example query results 550 after an API produced by the file system 154 (as further described below with reference to FIG. 7) in response to a read directory command directed to the virtual directory 152-2 (FIG. 4B), which results in the query 164-2 being performed by the file system 154 against the directory 150 (FIG. 2), and further in response to a file command (as further described below with reference to FIG. 11), according to an embodiment of the invention.

FIG. 6 depicts a flowchart of example processing for creating a directory, according to an embodiment of the invention. Control begins at block 600. Control then continues to block 605 where the file system 154 receives a create new directory command with a directory name (e.g., the directory name 305) and query (e.g., the queries 164-1 or 164-2) from the application 160, as previously described above with reference to FIGS. 3A and 3B. Control then continues to block 610 where the file system 154 creates a new directory, such as the directory 152. Control then continues to block 615 where the file system 154 stores the received query in the query 164 in the directory node of the new directory 152. Control then continues to block 699 where the logic of FIG. 6 returns.

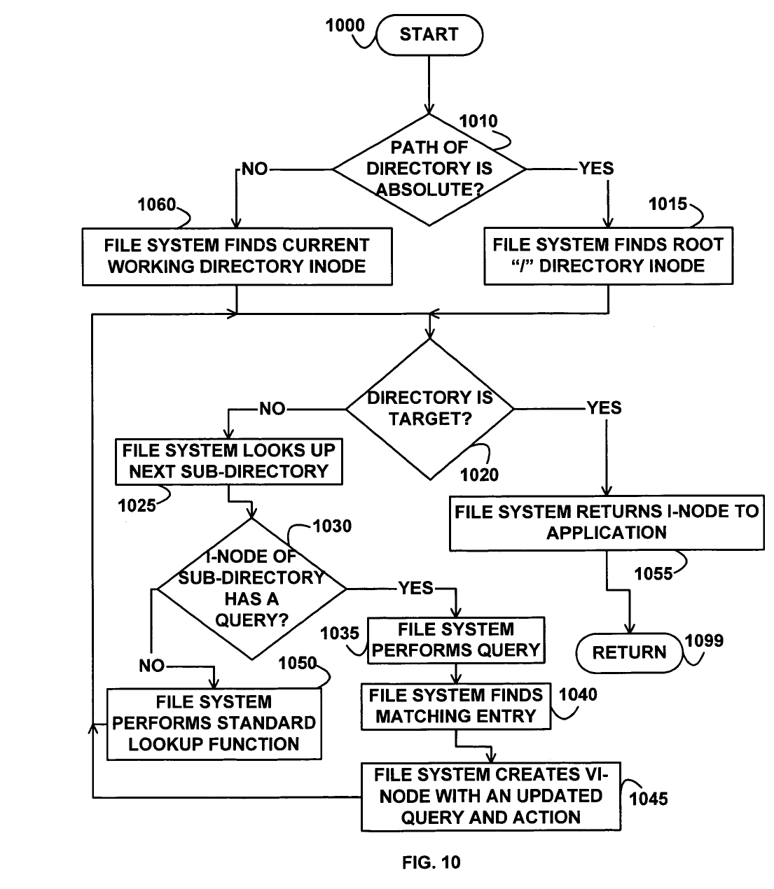

FIG. 7 depicts a flowchart of example processing for reading a directory, according to an embodiment of the invention. Control begins at block 700. Control then continues to block 705 where the application 160 sends a read directory command for a directory 152 to the file system 154. Control then continues to block 707 where the file system 154 finds an i-node of the directory 152, as further described below with reference to FIG. 10. Control then continues to block 710 where the file system 154 determines whether the directory 152 has an associated query 164.

If the determination at block 710 is true, then the directory 152 has an associated query 164, so control continues to block 715 where the file system 154 performs the query 164 against the entity (e.g., the directory 150) specified in the query 150. Control then continues to block 720 where the file system 154 returns the results from the query 164 to the application 160. Control then continues to block 799 where the logic of FIG. 7 returns.

If the determination at block 710 is false, then the directory (e.g, the directory 150) does not have an associated query 164, so control continues to block 725 where the file system 154 returns the contents of the directory to the application 160. Control then continues to block 799 where the logic of FIG. 7 returns.

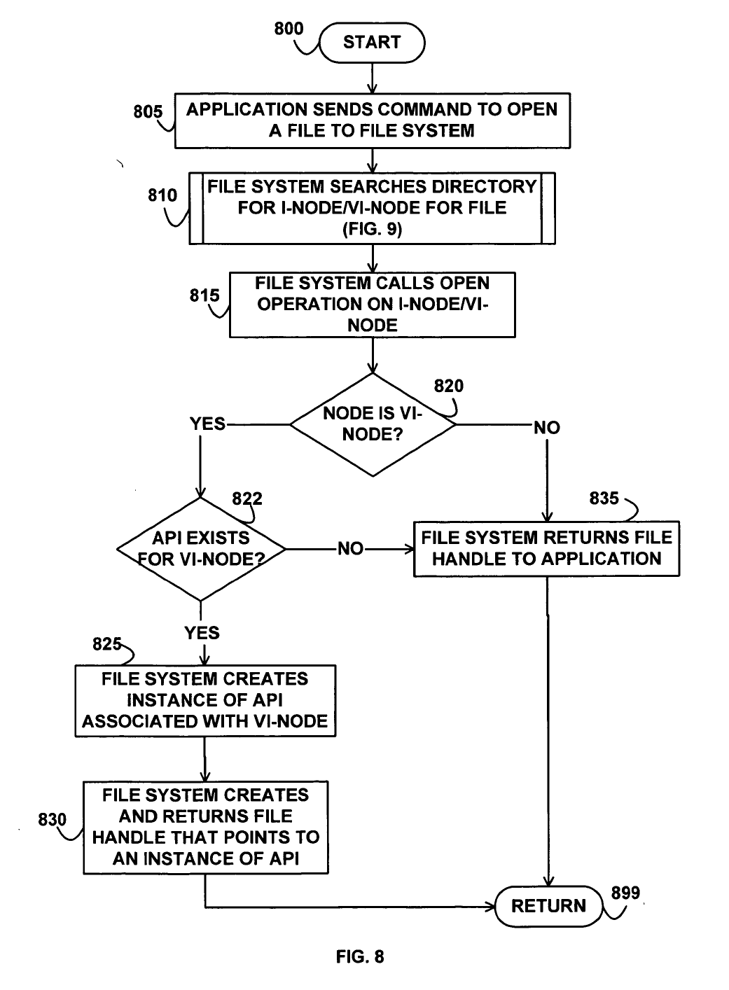

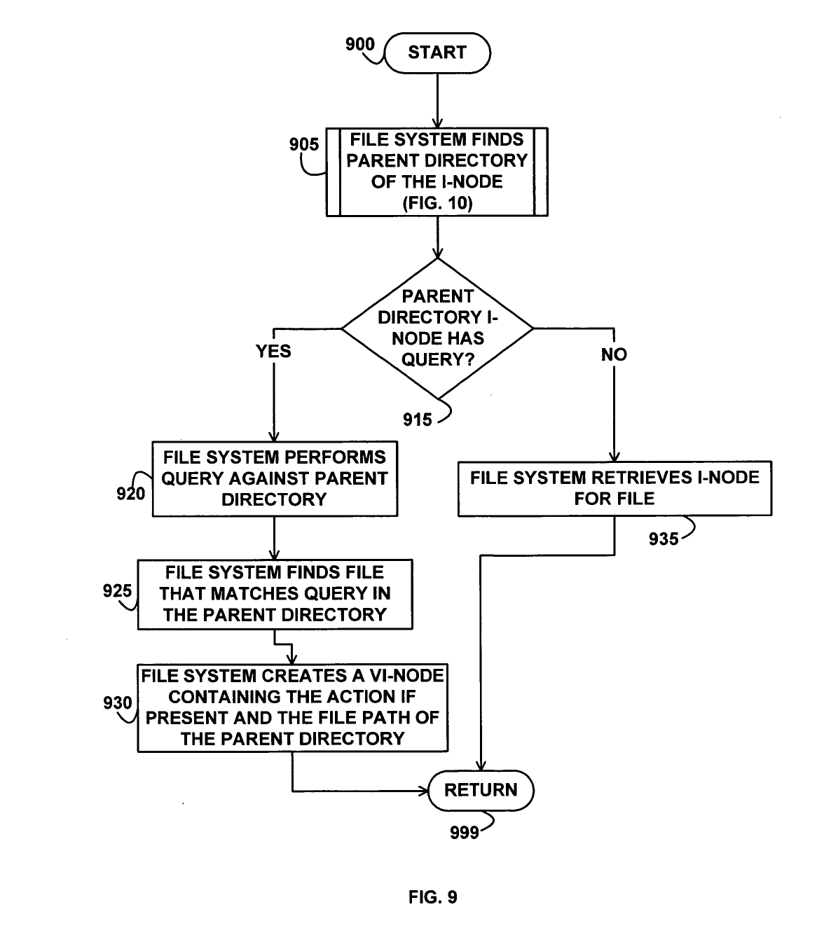

FIG. 8 depicts a flowchart of example processing for opening a file, according to an embodiment of the invention. Control begins at block 800. Control then continues to block 805 where the application 160 sends a command or request to open a file 162 in a directory to the file system 154. Control then continues to block 810 where the file system 154 searches the directory for an i-node/vi-node for the specified file, as further described below with reference to FIG. 9. Control then continues to block 815 where the file system 154 opens the i-node/vi-node. Control then continues to block 820 where the file system 154 determines whether the node is an vi-node 158.

If the determination at block 820 is true, then the node is a vi-node 158, so control continues to block 822 where the file system 154 determines whether an associated API exists for the VI-node 158. If the determination at block 822 is true, then control continues to block 825 where the file system 154 creates an instance of the API associated with the vi-node 158 if the API exists. Control then continues to block 830 where the file system 154 creates and returns a file handle that points to the instance of the API to the application 160. That is, the file system 154 stores a pointer to the instance of the API in the file handle. Control then continues to block 899 where the logic of FIG. 8 returns.

If the determination at block 822 is false, then control continues to block 835 where the file system 154 returns a file handle of the file 162 associated with the vi-node 158 to the application 160.

If the determination at block 820 is false, then the node is an i-node 156, so control continues to block 835 where the file system 154 returns a file handle of the file 162 associated with the i-node 156 to the application 160. Control then continues to block 899 where the logic of FIG. 8 returns.

FIG. 9 depicts a flowchart of example processing for searching the directory 152 for an i-node/vi-node, according to an embodiment of the invention. Control begins at block 900. Control then continues to block 905 where the file system 154 finds the parent directory of the i-node, as further described below with reference to FIG. 10. Control then continues to block 915 where the file system 154 determines whether the parent directory i-node has an associated query.

If the determination at block 915 is true, then the parent directory i-node has an associated query, so control continues to block 920 where the file system 154 performs the query against the parent directory. Control then continues to block 925 where the file system 154 finds the file 162 that matches the query in the parent directory. Control then continues to block 930 where the file system 154 creates a vi-node containing the query, action (if present), and the file path of the parent directory. Control then continues to block 999 where the logic of FIG. 9 returns.

If the determination at block 915 is false, then the parent directory i-node does not have an associated query, so control continues to block 935 where the file system 154 retrieves the i-node for the file. Control then continues to block 999 where the logic of FIG. 9 returns.

FIG. 10 depicts a flowchart of example processing for finding a parent directory of an i-node, according to an embodiment of the invention. Control begins at block 1000. Control then continues to block 1010 where the file system 154 determines whether the path of the directory is absolute. An absolute path is fully qualified, that is, it specifies all the subdirectories and directories that contain the specified directory. In the Unix file system, for example, an absolute path begins with a “/” and starts with the root directory. A path that is not absolute is relative, i.e., it starts with the current directory.

If the determination at block 1010 is true, then the path of the directory is absolute, so control continues to block 1015 where the file system 154 finds the root (e.g., the “/”) directory i-node. Control then continues to block 1020 where the file system 154 determines whether the current found directory is the target of the read directory command.

If the determination at block 1020 is false, then the current directory is not the target of the read directory command, so control continues to block 1025 where the file system 154 finds the next sub-directory. Control then continues to block 1030 where the file system 154 determines whether the i-node of the sub-directory has an associated query.

If the determination at block 1030 is true, then the i-node of the sub-directory has an associated query, so control continues to block 1035 where the file system 154 performs the query. Control then continues to block 1040 where the file system 154 finds a matching entry for the file 162 in the query results. Control then continues to block 1045 where the file system 154 creates a vi-node 158 with an updated query and action. Control then returns to block 1020, as previously described above.

If the determination at block 1030 is false, then the i-node of the sub-directory does not have an associated query, so control continues to block 1050 where the file system 154 performs a standard lookup function for the file 162 in the sub-directory. Control then returns to block 1020, as previously described above.

If the determination at block 1020 is true, then the directory is the target of the read directory command, so control continues to block 1055 where the file system 154 returns the i-node 156 to the application 160. Control then continues to block 1099 where logic of FIG. 10 returns.

If the determination at block 1010 is false, then the path of the directory is relative instead of absolute, so control continues to block 1060 where the file system 154 finds the current working directory i-node 156. Control then continues to block 1020, as previously described above.

FIG. 11 depicts a flowchart of example processing for performing a file operation, according to an embodiment of the invention. Control begins at block 1100. Control then continues to block 1105 where the application 160 sends a file operation, e.g., read, seek, write, or clear) command or request directed at a file handle to the file system 154. Control the continues to block 1110 where the file system 154 determines whether an API instance exists in the file handle; that is, the file system 154 determines whether the file handle contains a pointer that points to an API instance.

If the determination at block 1110 is true, then an API instance exists in the file handle, so control continues to block 1115 where the file system 154 passes the command or request to the API. Control then continues to block 1199 where the logic of FIG. 11 returns.

If the determination at block 1110 is false, then an API instance does not exist in the file handle, so control continues to block 1120 where the file system 154 performs the command or request. Control then continues to block 1199 where the logic of FIG. 11 returns.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of embodiments of the invention. But, the invention may be practiced without these specific details. In other instances, well-known circuits, structures, and techniques have not been shown in detail in order not to obscure the invention.

What is claimed is:

1. A method comprising:
receiving a read command directed to a first directory;
determining whether the first directory has an associated query; and
performing the query against a second directory if the determining is true.

2. The method of claim 1, further comprising:
returning results of the query in response to the read command.

3. The method of claim 1, further comprising:
receiving an open command directed to a file in the first directory;
deciding whether the first directory has an associated query; and
performing the query against the second directory and finding the file in results of the query if the deciding is true.

4. The method of claim 3, further comprising:
creating a file handle associated with the file; and
returning the file handle to an application that sent the open command.

5. The method of claim 4, wherein the creating the file handle further comprises:
determining whether the query has an associated API; and
creating an instance of the associated API and storing a pointer to the instance of the API in the file handle if the query has the associated API.

6. The method of claim 5, further comprising:
receiving a file operation command directed to the file handle;
determining whether the file handle contains the pointer to the instance of the API; and
if the file handle does contain the pointer to the instance of the API, passing the file operation command to the instance of the API.

7. A signal-bearing medium encoded with instructions, wherein the instructions when executed comprise:
receiving a read command directed to a first directory;
determining whether the first directory has an associated query; and
performing the query against a second directory if the determining is true.

8. The signal-bearing medium of claim 7, further comprising:
returning results of the query in response to the read command.

9. The signal-bearing medium of claim 7, further comprising:
receiving an open command directed to a file in the first directory;
deciding whether the first directory has an associated query; and
performing the query against the second directory and finding the file in results of the query if the deciding is true.

10. The signal-bearing medium of claim 9, further comprising:
creating a file handle associated with the file; and
returning the file handle to an application that sent the open command.

11. The signal-bearing medium of claim 10, wherein the creating the file handle further comprises:
determining whether the query has an associated API; and
creating an instance of the associated API and storing a pointer to the instance of the API in the file handle if the query has the associated API.

12. The signal-bearing medium of claim 11, further comprising:
receiving a file operation command directed to the file handle; and
determining whether the file handle contains the pointer to the instance of the API.

13. The signal-bearing medium of claim 12, further comprising:
if the file handle does contain the pointer to the instance of the API, passing the file operation command to the instance of the API.

14. A method for configuring a computer, comprising:
configuring the computer to receive a read command directed to a first directory;
configuring the computer to determine whether the first directory has an associated query; and
configuring the computer to perform the query against a second directory if the first directory has an associated query.

15. The method of claim 14, further comprising:
configuring the computer to return results of the query in response to the read command.

16. The method of claim 14, further comprising:
configuring the computer to receive an open command directed to a file in the first directory;
configuring the computer to decide whether the first directory has an associated query; and
configuring the computer to perform the query against the second directory and find the file in results of the query if the first directory has an associated query.

17. The method of claim 16, further comprising:
configuring the computer to create a file handle associated with the file; and
configuring the computer to return the file handle to an application that sent the open command.

18. The method of claim 17, wherein the configuring the computer to create the file handle further comprises:
configuring the computer to determine whether the query has an associated API; and
configuring the computer to create an instance of the associated API and store a pointer to the instance of the API in the file handle if the query has the associated API.

19. The method of claim 18, further comprising:
configuring the computer to receive a file operation command directed to the file handle; and
configuring the computer to determine whether the file handle contains the pointer to the instance of the API.

20. The method of claim 19, further comprising:
configuring the computer to pass the file operation command to the instance of the API if the file handle does contain the pointer to the instance of the API.
